(19) United States
(12) Patent Application Publication
(10) Pub. No.: US 2008/0169968 A1
(43) Pub. Date: Jul. 17, 2008

(54) MANAGEMENT OF TRACKING MODELS

(76) Inventors: Paul Easthope, Alton (GB); Kevin Smith, Farnham (GB); Tim Waggett, Aldershot (GB)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 11/852,641

(22) Filed: Sep. 10, 2007

(30) Foreign Application Priority Data
Mar. 8, 2005 (GB) 0504889.7
Mar. 8, 2006 (GB) PCT/GB2006/000827

(51) Int. Cl. G01S 13/72

(52) U.S. Cl. 342/95

(57) ABSTRACT

The present invention relates to methods and apparatus for tracking moving objects, such as ballistic missiles and aircraft, on the basis of discrete sensor measurements, such as radar reports and reports from optical sensors. In particular, but not exclusively, the invention is useful for the simultaneous tracking of multiple, fast moving, closely spaced objects, such as deploying ballistic missiles and raids of fast agile aircraft, in which the track dynamics of each object are modelled using a collection of autonomous, i.e. non-interacting, multiple dynamics models. Embodiments of the invention were particularly developed to be effective in tracking ballistic missiles using early warning radar, and similarly demanding and complex battle scenarios.

### CROSS REFERENCE TO RELATED APPLICATIONS

This patent application claims priority to International Application PCT/GB2006/000827 filed on Mar. 8, 2006 which claims priority to GB application no. 0504889.7 filed Mar. 8, 2005, entitled, “MANAGEMENT OF TRACKING MODELS”, the contents and teachings of which are hereby incorporated by reference in their entirety.

The present invention relates to methods and apparatus for tracking moving objects, such as ballistic missiles and aircraft, on the basis of discrete sensor measurements, such as radar reports and reports from optical sensors. In particular, but not exclusively, the invention is useful for the simultaneous tracking of multiple, fast moving, closely spaced objects, such as deploying ballistic missiles and raids of fast agile aircraft, in which the track dynamics of each object are modelled using a collection of autonomous, i.e. non-interacting, multiple dynamics models. Embodiments of the invention were particularly developed to be effective in tracking ballistic missiles using early warning radar, and similarly demanding and complex battle scenarios.

We refer to the tracked moving objects as targets of the tracking system. Tracking systems accept reports from sensors and combine the reports to output one or more estimated tracks of targets. For example, two separate radar systems could each produce intermittent sensor reports of radio waves reflected from multiple aircraft, in terms of azimuth, elevation and range. A tracking system may then use these sensor reports to continually update estimated tracks of the aircraft flight paths.

By associating multiple sensor reports with a single logical track deemed to represent a target, it is possible to deduce parameters such as object velocity as well as position, and to better decide which sensor reports should be incorporated into the estimation of which track. Commonly, this is achieved with a data processing technique using Kalman filters (“New Results in Linear Filtering and Prediction Theory”, Kalman R. E. and Bucy, R. S., Trans ASME, Journal of Basic Engineering, March 1961) implemented in software on suitable dedicated or general purpose computer hardware.

Kalman filters provide an efficient and recursive way to estimate the state variables of a process, in a way that continually seeks to minimise the error between the estimated state variables and the underlying trajectory. To improve tracking methods, assumptions about the process dynamics are built into the track estimation process. For the tracking of civil aircraft, a limited number of different descriptions of the possible process dynamics may be suitable, for example describing level flight, climbing/descending, and turning. Level flight dynamics may assume a fixed velocity in a straight line, requiring only position and velocity state variables, while climbing/descending dynamics may assume a constant rate of change of altitude. For military scenarios, different dynamics may be suitable for describing different types of ballistic and non-ballistic missile trajectories, helicopter dynamics and the wider range of possible aircraft dynamics.

The most appropriate description of the process dynamics may change at any time, for example when an aircraft turns sharply following a period of straight level flight, or when a ballistic missile ceases powered flight. For this reason, many modern tracking systems simultaneously maintain multiple versions or models of target behaviour, each model applying a different one of the possible physical behaviour types or dynamics to the available sensor reports. The use of such multiple dynamics models in tracking methods is well known—see, for example S. S. Blackman and R. Popoli, Artech House, 1999, “Design and Analysis of Modern Tracking Systems”.

In order to maintain association between the multiple models of a single track, for example to prevent the models from diverging too much, the multiple models are usually arranged such that they interact in some way. Simplistically, each model could be adjusted using a weighted contribution from all the other models of the track. Such arrangements are generally described as Interacting Multiple Models (IMMs), and are described in detail in the above Blackman and Popoli reference. Estimated state variables from the models such as position and velocity may be combined together to form a composite track, which may be used for gating new sensor reports. Gating is discussed below.

An alternative approach is to use multiple models which do not interact significantly, if at all. Such arrangements may be referred to as Autonomous Multiple Models (AMMs). The use of autonomous multiple models overcomes particular problems such as how to combine multiple models with different numbers of state variables, reduces computational overheads accrued in the model interaction process, and can result in a tracking process which responds more quickly to changes in track dynamics. Although interacting multiple models have been more extensively discussed, a recent publication relating to autonomous models is A. T. Alouani and J. E. Gray, Proc SPIE Acquisition, Tracking and Pointing XVII, Vol. 5082, 2003.

In most known tracking systems, sensor reports are allocated to tracks by a process of gating and assignment. Usually, each track is extrapolated forward in time to the time of the new sensor report and a likelihood of the sensor report belonging to a particular track is thereby ascertained. The gating process provides a statistical yes/no decision regarding whether the track should (or should not) be updated with that sensor report. However, difficulties may arise if, even after the gating process, it is not clear to which of several possible tracks a sensor report should be allocated, or if the sensor report should be used to start a new track. The allocation of sensor reports to particular tracks has been the focus of much discussion and research. Simplistic solutions merely allocate a sensor report to a closest track, such as in the well known nearest-neighbour and global nearest neighbour approaches.

More sophisticated approaches seek to delay finalising allocation of sensor reports to tracks until more data has been obtained. In the meantime, multiple hypotheses about how the sensor data may be allocated are maintained. The less likely hypotheses are pruned away as more sensor reports arrive and the appropriateness of different earlier allocation options become apparent. This approach is generally known as Multi Hypothesis Tracking (MHT), and is reviewed in detail in S. S. Blackman, “Multiple Hypothesis Tracking for Multiple Target Tracking”, IEEE A&E Systems Magazine Vol 19 no. 1, 1994.

In track-oriented MHT, discussed in the same article, hypotheses are not maintained and expanded as sensor reports are incorporated. Instead, new track segments and branches are formed as required to take account of new sensor reports and different allocation options. The track tree is continually or intermittently pruned to remove redundant or low probability tracks and track segments.

The Blackman article also discusses the formation and pruning of sensor report allocation hypotheses in the context of interacting multiple models, advocating the formation, development and pruning of sensor report allocation hypotheses on the basis of a composite track formed from all the models of a track. Blackman prefers gating of new sensor reports on the basis of individual models.

Any tracking system that is required to operate in an environment containing multiple targets must take account of the correct association of sensor reports with tracks. In the majority of cases the sensor itself cannot provide any indication of report origin. Where a sensor report is used to update the wrong track, or a spurious sensor report is used to update a track, a miscorrelation has occurred. On the other hand, a change in behaviour of a target, or manoeuvre, may require a track to update on what appears to be a rather unlikely sensor report.

### SUMMARY OF THE INVENTION

The invention seeks to address problems and limitations of the related prior art. In general, the invention applies to tracking systems which simultaneously maintain a plurality of tracks, each track containing a set of model processes to represent the different possible dynamics of the tracked target. In particular the invention is applied to such systems in which the models are allowed to behave, and update using sensor reports, largely or entirely independently or autonomously of each other. Control of the set of models and their logical groupings into tracks is asserted by a separate control process of model and track initiation, splitting and termination.

Within this context, the invention provides a number of rules which enable a tracking system to discriminate between miscorrelation and manoeuvre, by comparing sets of models at current and prior times and, where necessary, across track processes, to effect an intelligent and significant reduction in potential track hypotheses.

If a best model for a set of models logically grouped into a track changes from one sensor report update to the next then it may be inferred that a miscorrelation or a manoeuvre may have occurred. To allow for both possibilities, the track is split into two.

Comparison of the model processes which have all updated with the same sensor report can be used to show whether two sets of models have overlapped and thus whether a miscorrelation may have occurred. In particular, if model processes with different track identities have updated using the same sensor report then it is inferred that at least some of the updates must be miscorrelations.

If all the models in a track are following the same physical target then they will tend to overlap in both position and velocity. Overlap in position will arise from models updating from a common sensor report, but models with inconsistent velocities are likely to have had rather different recent histories, and may well have been updating on different targets.

For dynamic continuity to be maintained it is expected that the identities of the models for a track should show at least some overlap from update to update. If this is not the case then the present or the prior update was probably a miscorrelation. In certain cases the best model within a set may exhibit alternating behaviour, which similarly indicates alternating miscorrelation.

According to one aspect the invention provides a method of generating and/or maintaining multiple target tracks in response to sensor reportings by deciding, separately for each autonomous or quasi autonomous model within each track, whether or not to accept a new sensor report, and using the new sensor report, updating only models which decided to accept.

The method may further comprise selecting, from those models deciding to accept, a particular subset of models to update, for example only models from a single track or a single hypothesis tracking process within a track. To ensure the updated models form part of a complete group of model types, the model types missing from the updated set may be initialised, for example, from a selected best one of the updated set.

Generally, a sensor report may be a report from a sensor providing space and time location information of a sensed object, for incorporation into the target tracks.

Embodiments of the invention may be implemented as a method executed on appropriate general purpose or dedicated computer systems, as such computer systems appropriately arranged or configured, as software stored on one or more suitable computer readable media, or as a software product as such. Embodiments of the invention may also include apparatus for providing sensor reports, such as radar data processing hardware, or even a full radar or other sensing system, and display equipment for presenting the products of the implemented invention in the form of output tracks or track information.

### DETAILED DESCRIPTION OF PREFERRED EMBODIMENTS

Embodiments of the invention will now be described, by way of example only, and with reference to the accompanying drawings, of which:

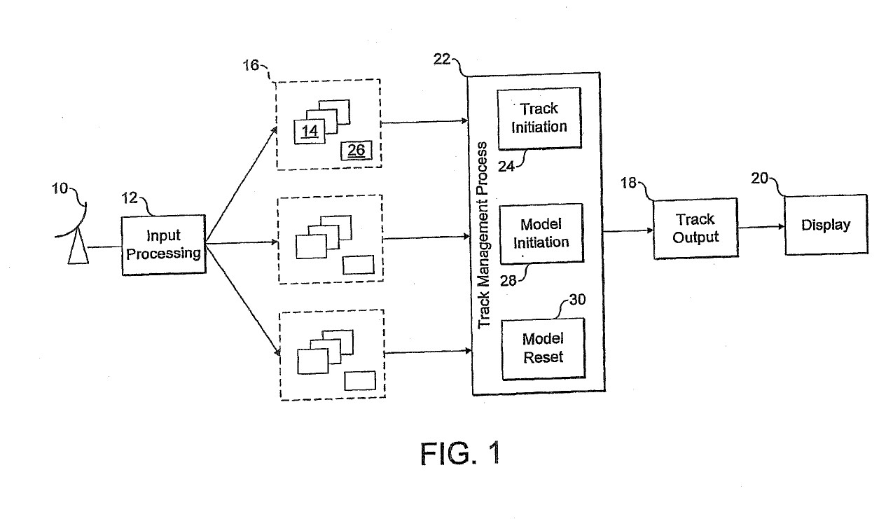

FIG. 1 is a schematic overview of an autonomous multiple model tracking system embodying the invention;

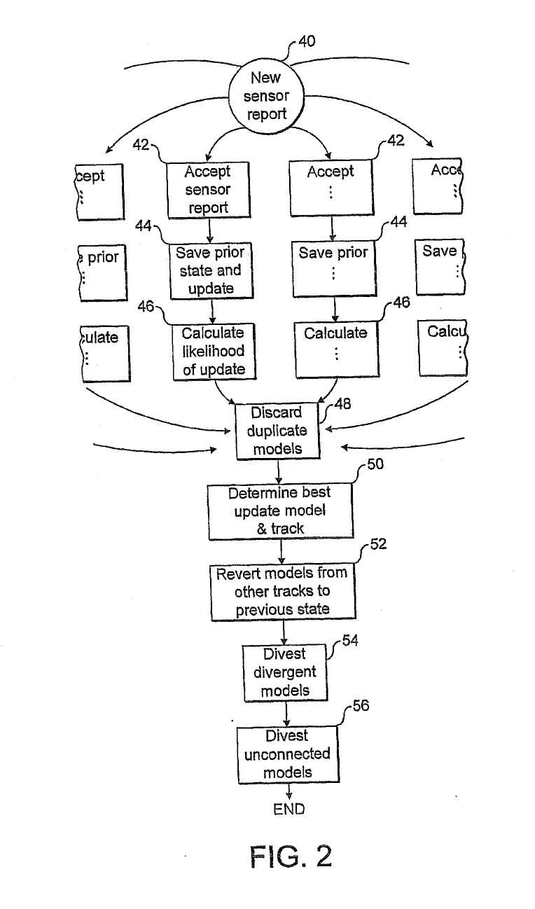

FIG. 2 is a flow diagram of a portion of a first process which may be put into effect by the track management system shown in FIG. 1;

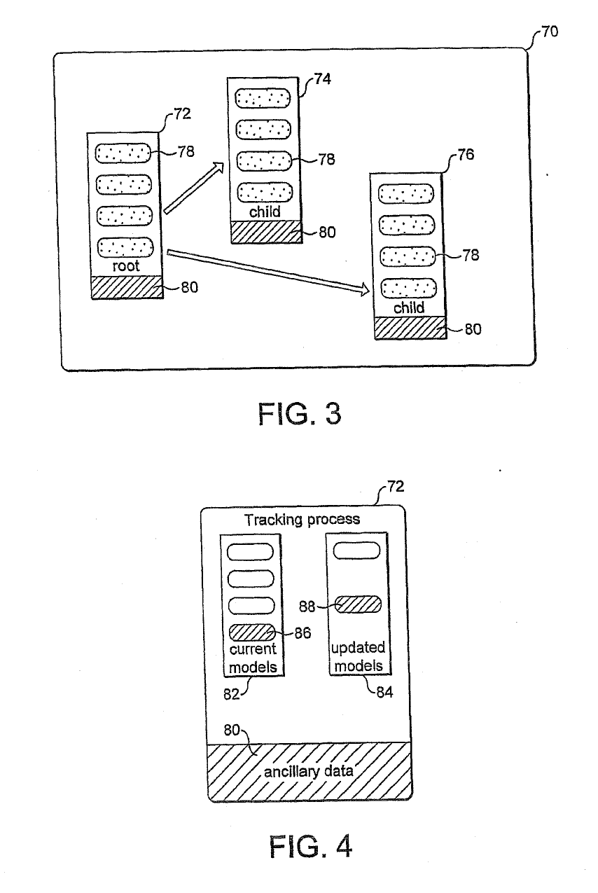

FIG. 3 illustrates hypothesis tracking processes within a track;

FIG. 4 shows further detail of a tracking process of FIG. 3;

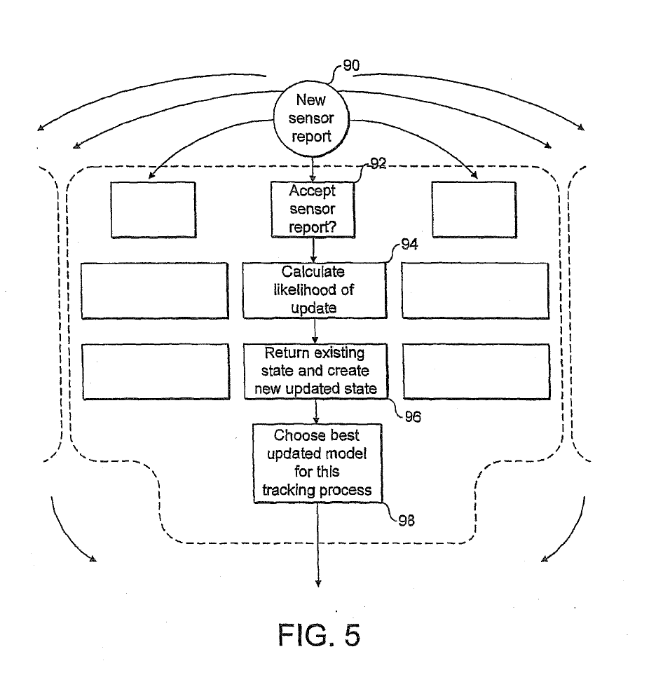

FIG. 5 is a flow diagram of a first part of second process which may be put into effect by the track management system shown in FIG. 1, using tracks and tracking processes as illustrated in FIGS. 3 and 4; and

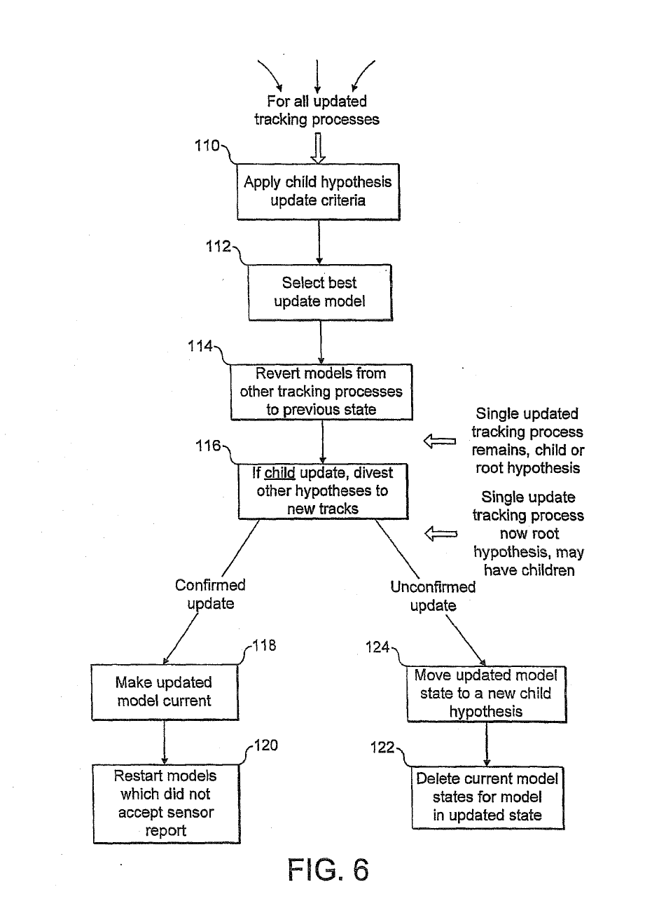

FIG. 6 is a flow diagram of a second part of the process of FIG. 5.

It is assumed, in the subsequent discussion, that the reader is familiar with the following fundamental processes:
Track Initiation, the process by which position, velocity and their associated uncertainties are extracted from sensor measurements.
Track Gating, in which an incoming sensor report is statistically compared to an existing track, giving a basic Yes/No decision as to whether that track should be updated or not.
Track Update, in which a new sensor measurement is incorporated into an existing track.

These steps are characteristic of most Kalman filter implementations and the detailed steps need not be repeated here.

### Structural Overview

Referring first to FIG. 1 there is shown a schematic overview of a tracking system embodying the invention. Sensor reports are received from one or more originating remote sensing devices 10 which may operate using, for example, radar, optical, infrared or acoustic signals. Each sensor report may typically comprise a time stamp and a measurement of spatial position. For a radar, the position will usually include a range and an angle, while for a passive electro-optical device only an angle will be included.

The sensor reports are passed to a sensor report input process 12. The sensor reports are then passed onto a plurality of tracking models 14 which are logically grouped into tracks 16. The outputs from the tracking models 14 are selectively used by a track output process 18 to forward suitable track data onto a display 20.

In a first embodiment described below, each track contains a single set of tracking models 14. In a second embodiment, each track contains one or several subordinate tracking processes, each such process containing a single set of tracking models, each process representing a different hypothesis about the development of the track.

The tracks 16 and their included tracking models 14 incorporate functionality 26 for the termination of existing tracks but are further managed by a track management process 22, which handles functions such as the initiation of new tracks 24, the initiation of new models 28 and the resetting of existing models 30.

The sensor report input process 12 may carry out a variety of pre-processing operations such as coordinate conversions, removal of known biases, ensuring that all sensor reports conform to a particular data format, ensuring a particular time stamp order, and so on. This process could also carry out a preliminary or coarse gating function to identify to which of the tracks 16 a sensor report may be relevant.

Each logical track 16 is intended to follow a single target on the basis of the sensor reports. In order to model effectively the wide range of physical behaviours, or dynamics, which may be exhibited by a target, each track 16 is comprised of a set of several tracking models 14. Each model applies different assumptions about the expected behaviour of the target. For example, a comprehensive system might include, for each track, models for each flight phase of ballistic missiles, plus models designed more specifically for air-breathing targets, including aircraft and high-manoeuvre endo-atmospheric missiles, as well as ships and helicopters. Some implemented embodiments use eleven different models for each track.

Each model is represented by a current model state, which includes at least a state vector and a covariance matrix, and some dynamics rules relevant to the model type. The state vector contains basic target state variables such as position and velocity, and may contain further variables such as acceleration, turn rate and aerodynamics parameters. A Kalman filter technique is used to update a model state to incorporate a new sensor report. The probability of the update being appropriate is determined by how well the new sensor report fits with an extrapolation of the model, within the constraints of the model dynamics, to the time of the new sensor report.

Each model decides for itself whether or not to update on the basis of a new sensor report, independently of the states or update decisions of the other models in the same and other tracks. Moreover, there is no data flow directly between models or tracks, which therefore proceed independently on the basis of the received sensor reports. Instead, most of the track and model management is carried out by the track management process 22, which is limited in its control to initiating, splitting and terminating tracks, and to initiating and resetting individual models within specific tracks.

### First Embodiment

### Detailed Process

FIG. 2 is a flow diagram illustrating the processing carried out in respect of a new sensor report 40. Sensor reports may be used both to initiate new tracks and to update existing track models. Only the update process will be considered in detail here.

Each sensor report is sent to all of the models 14. Each sensor report is processed independently and completely before proceeding to the next one. Each model applies a gating process at step 42 to decide whether or not to update using the sensor report, using techniques familiar in the field of tracking using Kalman filters. Any model that accepts a sensor report creates a copy of its prior state as a separate model process and updates using the sensor report, at step 44.

Each model that updates using the new sensor report calculates, at step 46, a likelihood of the update based on a weighted distance measure and the model residual covariance matrix.

The set of models which has updated is further processed in steps 48 to 56 within the track management process 22. At this stage, the models may be from different tracks, and there may be from zero to all of the models from any one track in the set.

In step 48, the set is examined for pairs or groups of model processes which have the same dynamics type and approximately the same position and velocity. Such duplicates can arise as a consequence of the track initiation process which is not described in this document. If one or more duplicates are found then only the longest lived model is retained.

In step 50 a probability of each model is determined on the basis of a normalised product of the probability of the model at its previous update and the likelihood of the update mentioned above. The model with the highest probability is chosen as a best model for the set.

In step 52, the models which belong to the same track as the best model are retained and all the other models are reverted to their states prior to the update, using the prior state copy saved at step 44. The prior state copies of the retained models may now be discarded.

In step 54 the remaining models of the set, which all belong to the same track, are assessed for divergence. Although the models are likely to have similar position states because they all updated using a single sensor report, one or more of the models may have a velocity state component or other state component which is inconsistent with the other models or with an average of the other models. If any model is found to be sufficiently divergent then a new logical track is formed. The divergent model is assigned to the new track and a complete set of models for the track is constructed based on the divergent model.

In step 56 the remaining set of models is compared with the set of models for the same track which most recently updated on a previous sensor report. If there are no models in common between the two sets then it may be concluded that the current update for this track is dynamically inaccessible from the previous update. In this case, if the size of the current update set is larger than the size of the previous update set then a new track is created. The models of the previous update set are assigned to the new track and new models are constructed to make up a complete set. Preferably, the track output passed by the track output process 18 to the display 20 is altered to remove the previous update.

### Second Embodiment

### Overview

According to an alternative embodiment, each track 16 as illustrated in FIG. 1 contains one or more subordinate tracking processes as shown in FIG. 3. The tracking processes within a track 70 are all related in the sense that one tracking process is designated the “root hypothesis” 72 and all other tracking processes 74, 76 that are part of the same track stem directly from this root. These additional tracking processes are called “child hypotheses”. Typically, root and child hypotheses are generated in response to situations where it is unclear from the received sensor reports whether a manoeuvre or a miscorrelation has occurred.

Each tracking process 72, 74, 76 contains one or more tracking models, or states for such tracking models, 78 as described above in connection with FIG. 1, where the complete set of model types preferably spans the expected dynamic behaviour of the targets of interest. Each model contains a state vector, covariance and associated information. Each tracking process also contains ancillary data 80 relating to the contained models, such as the identity of the best model and sensor report reject/accept status flags.

A tracking process 72 is illustrated in more detail in FIG. 4. A first set of model states 82 contains current states for all available models 78. A second set of model states 84 contains updated states for none, some or all of the available models depending on whether each model chooses to update on the basis of a particular sensor report. One of the current model states 82 is identified as the current best model 86, and one of the updated states is identified as the best updated model 88. The updated states 84 are associated with a particular new sensor report 90.

### Second Embodiment

### Detailed Process

Each incoming sensor measurement is processed independently and completely before proceeding to the next one. Each sensor report also undergoes whatever coordinate conversions may be necessary, removal of known biases and so on. The detailed sequence of process steps is illustrated in FIGS. 5 and 6.
1. Each new sensor report is sent to all tracking processes, 72, 74, 76 each of which in turn sends the data to its constituent models 78.
2. For each model 78, a gating process 92 is applied to the sensor report. The result will be an accept (the model will update using the sensor report) or reject (the sensor data is inapplicable).
3. Any model that accepts a sensor report calculates 94 a likelihood, defined in equation (1) below. It also creates 96 an updated model state from the current model state combined with the accepted sensor report using techniques familiar in the field of tracking. The current model state is retained unchanged (also step 96).
4. Each model process 78 returns the accept/reject result of its gating operation to the tracking process of which it is part. If the gating result was to accept the report (so that the model process created an updated model state) then the probability associated with the updated model state is also passed to the tracking process.
5. Each tracking process accumulates the accept/reject results and associated probabilities for its constituent models, for example in an ancillary data area 79 as shown in FIG. 3. If any constituent model accepted the sensor report then the tracking process chooses 98 the updated model state with the highest probability as the best updated model.
6. At this stage of the process, the new sensor report 90 has been associated with one or more tracking processes. Each such tracking process contains the current state 82 for each model, and updated states 84 for one or more models (according to whether that model accepted the sensor report). At step 98, one of the current model states is identified as the “current best model” 86 and one of the updated models states is identified as the “best updated model” 88.
7. Referring now to FIG. 6, for each updated tracking process that represents a child hypothesis, logical criteria are applied at step 110. These criteria determine whether the tracking process will reject the update as a probable miscorrelation. Various versions of this logic may be used, but only a single option is described here:
   (a) If the current best model is the same model type as the best model of the root hypothesis, accept the update.
   (b) Otherwise, if the best current model has a corresponding updated model state, accept the update.
   (c) Otherwise, if the best updated model has not just been initiated in the current model state, accept the update.
   (d) Otherwise reject the update.
8. If a tracking process rejects an update then all its updated model states are discarded, returning the tracking process to the state it was in before the sensor report was received.
9. Of the remaining updated model states (namely those that are not discarded by the miscorrelation logic), the one with the highest probability is chosen 112 as the best model for the update. The updated model states belonging to tracking processes different to that of the best model are discarded at step 114, returning all tracking processes except the one containing the best remaining model to the state they were in before the sensor report was received.
10. At this stage of the process, after step 114 in FIG. 6, the sensor report has been allocated to a single tracking process. This tracking process is referred to as the updated tracking process in the following text. The updated tracking process contains the current state for each model and an updated state for one or more models (according to whether the model accepted the sensor report or not). One of the current model states is identified as the “current best model” and one of the updated models states is identified as the “best updated model”.
11. If the updated tracking process is a child hypothesis, then every other child hypothesis and the root hypothesis are ejected from the updated track in step 116. Each ejected child hypothesis becomes the root hypothesis of a new single-hypothesis track. The ejected root hypothesis will not contain a full set of model states, and the set of models is then completed by spawning from the local ‘best’ model at step 118. If the ejected root hypothesis contains at least one updated model state it will also become the root hypothesis of a new single-hypothesis track; otherwise the root hypothesis is discarded.
12. At this stage of the process, the updated tracking process is always the root hypothesis of a track.
13. A number of logical criteria are applied to determine the development of hypotheses within the updated track. These criteria determine whether the update is treated as confirmed or unconfirmed. If the update is treated as confirmed, the prior model states of the updated tracking process will be discarded and replaced by the updated model states, otherwise both the prior and updated model states of the updated tracking process will be retained.
The following logical criteria are applied in order:
   (a) If the updated tracking process has just been initiated then the update is treated as confirmed.
   (b) If the updated track contains more than one tracking process (or, equivalently, if it contains at least one child hypothesis) then the update is treated as unconfirmed.
   (c) If the current best model did not accept the sensor report, then the update is treated as unconfirmed.
   (d) Otherwise the update is treated as confirmed.
14. If the update is treated as confirmed, the prior model state of the updated tracking process is discarded and replaced by the updated model state in step 118. Any models that did not accept the sensor report and so are not present in the updated model state are restarted using the state of the best updated model in step 120.
15. If the update is treated as unconfirmed, then the following operations take place:
   (a) The current model states for any models that occur in the updated model state are deleted, step 122.
   (b) The updated model state of the updated tracking process is moved to a new child hypothesis, step 124. Any models that did not accept the sensor report and so are not present in an updated model state are restarted using the state of the best updated model.
These operations ensure consistency across the model set.
16. At this point the input report is completely processed. Each tracking process contains only a current model state, since all the updated model states have been either discarded or copied into the current model state of another tracking process.
   Note that the above sequence of steps is concerned primarily with the situation in which there is ambiguity as to whether a sensor report represents a manoeuvre or a miscorrelation. In unambiguous cases where there is no such uncertainty, a single-hypothesis track will give rise to a confirmed update (step 13d).
   The likelihood associated with a track update is calculated according to the equation

$${L}_{k} = \frac{{e}^{- {d}^{2} / 2}}{{( 2 π )}^{m / 2} \sqrt{\vert S \vert}} , \qquad ( 1 )$$

at update k, where m is the measurement dimensionality,

d²=(z−Hx(−))^{T}S⁻¹(z−Hx(−)), (2)

is the weighted distance measure and S is the residual covariance matrix. The vector z stands for the measurement and x(−) for the extrapolated state vector.

The recursive probability associated with, and retained by, each Model Process is calculated according to the usual Bayesian formula:

$${μ}_{k} = \frac{{L}_{k} {μ}_{k - 1}}{{\sum }_{MPs} {L}_{k} {μ}_{k - 1}} , \qquad ( 3 )$$

where the sum is over all of the participating Model Processes.
A number of modifications and variations may be applied to the above described embodiments without departing from the spirit and scope of the invention as defined by the appended claims.

1. A method of operating a computer to generate multiple target tracks in response to sensor reports, comprising:
initiating tracks in response to sensor reports, each track comprising a plurality of autonomous track models, each model having a model state;
providing a new sensor report;
for each model, deciding whether to accept the new sensor report; and
using the new sensor report, updating only models which decided to accept.

2. The method of claim 1 further comprising the steps of:
selecting, from the models which decided to accept, the updated model with an optimum measure of probability; and
determining the track in which the selected model is comprised; and
reverting those updated models not comprised in the determined track to their respective states prior to update using the new sensor report.

3. The method of claim 1 further comprising the steps of:
for each model comprised in a track, selecting any model falling outside a measure of conformity with the models of the track; and
assigning the selected models to one or more newly created tracks.

4. The method of claim 3 wherein the measure of conformity is a measure of the conformity of velocity of the target represented by each model with an average target velocity for the track.

5. The method of claim 1 further comprising the steps of, for each track having models updated using the new sensor report:
determining if there are any models which updated using the new sensor report which did not update using the most recent previous sensor report used to update one or more models of the same track; and,
if there are any such models, assigning the models which updated using the previous sensor report to a newly created track.

6. The method of claim 5 wherein the step of assigning is carried out only if the number of models which updated using the new sensor report is greater than the number of models which updated using the previous sensor report.

7. The method of claim 1 wherein each track contains one or more tracking processes including at least one root hypothesis tracking process and optionally one or more child hypothesis processes, each tracking process comprising a separate set of autonomous track models.

8. The method of claim 7 further comprising the step of, using the new sensor report, creating from a root hypothesis tracking process a new child hypothesis tracking process.

9. The method of claim 7 further comprising the step of, using the new sensor report, creating from a child hypothesis tracking process a new child hypothesis tracking process, and ejecting all tracking processes except the new process from the track.

10. A method of operating a computer to generate multiple target tracks in response to sensor reports, comprising:
initiating and developing tracks in response to sensor reports, each track comprising one or more tracking processes including at least one root hypothesis process and optionally one or more child hypothesis processes formed from said root hypothesis using sensor reports, each tracking process comprising a plurality of autonomous track models of different model types, each model having a current model state;
providing a new sensor report; and
for each model of each tracking process, deciding whether to accept the new sensor report.

11. The method of claim 10 further comprising selecting a tracking process to update using the new sensor report, from the tracking processes containing at least one model deciding to accept the sensor report.

12. The method of claim 11 wherein the step of selecting a tracking process to update comprises:
for each tracking process containing at least one model deciding to accept the sensor report, selecting a best update model on the basis of a measure of consistency between the sensor report and each model;
applying child selection logic to accept or reject each said tracking process that is a child hypothesis tracking process.

13. The method of claim 11 further comprising the step of, if the selected tracking process is a child hypothesis process, ejecting the root and any other child hypothesis tracking processes from the same track to leave the selected child process as the root hypothesis process.

14. The method of claim 13 further comprising forming a new track from each ejected hypothesis.

15. The method of claim 11 further comprising applying confirmation logic to decide if the update of the selected tracking process is to be treated as confirmed or unconfirmed.

16. The method of claim 15 wherein, if the update is to be treated as confirmed, the models of the selected tracking process are updated, and prior states of the models are discarded.

17. The method of claim 15 wherein, if the update is to be treated as unconfirmed, the models of the selected tracking process which accepted the sensor report are used to start a new child hypothesis tracking process.

18. Computer apparatus for generating multiple target tracks in response to input sensor reports comprising means for putting into effect the steps of claim 1.

19. Computer apparatus for generating multiple target tracks in response to input sensor reports comprising means for putting into effect the steps of claim 10.

20. One or more computer readable media comprising computer program code adapted to put into effect the steps of claim 1.

21. One or more computer readable media comprising computer program code adapted to put into effect the steps of claim 10.

22. A tracking system comprising:
an input processor 12 adapted to accept sensor reports; and
a tracking processor adapted to maintain multiple target tracks in response to said sensor reports,
the tracking processor being arranged to represent each track using states of a set of tracking models, each model of the set having different process dynamics,
the tracking processor being arranged to decide, separately for each model state of each track, whether or not to accept a new sensor report for that model state and track.

23. The tracking system of claim 20 wherein the tracking processor is adapted to maintain, for each track, a root hypothesis comprising root hypothesis model states, and to derive from said root hypothesis model states, using sensor reports, corresponding child hypothesis states.

24. The tracking system of claim 21 wherein the tracking processor is adapted to select, for a particular new sensor report, a single hypothesis of a single track for update using the new sensor report.

25. The tracking system of claim 18 adapted to track at least one of ballistic missiles, aeroplanes, helicopters and non-ballistic missiles.

26. The tracking system of claim 19 adapted to track at least one of ballistic missiles, aeroplanes, helicopters and non-ballistic missiles.

27. The tracking system of claim 22 adapted to track at least one of ballistic missiles, aeroplanes, helicopters and non-ballistic missiles.
